(19) United States
(12) Patent Application Publication
(10) Pub. No.: US 2018/0011839 A1
(43) Pub. Date: Jan. 11, 2018

(54) SYMBOL PREDICTION WITH GAPPED SEQUENCE MODELS

(71) Applicant: Xerox Corporation, Norwalk, CT (US)

(72) Inventors: Matthias Gallé, Eybens (FR); Matías Hunicken, Córdoba (AR)

(73) Assignee: Xerox Corporation, Norwalk, CT (US)

(21) Appl. No.: 15/204,306

(22) Filed: Jul. 7, 2016

(51) Int. Cl. G06F 17/28; G06N 99/00; G06N 7/00; G10L 15/26; G10L 15/187

(52) U.S. Cl. CPC G06F 17/289; G10L 15/26; G10L 15/187; G06F 17/2818; G06N 7/005; G06N 99/005

(57) ABSTRACT

A symbol prediction method includes storing a statistic for each of a set of symbols w in at least one context, each context including a string of k preceding symbols and a string of l subsequent symbols, the statistic being based on observations of a string kwl in training data. For an input sequence of symbols, a prediction is computed for at least one symbol in the input sequence, based on the stored statistics. The computing includes, where the symbol is in a context in the sequence not having a stored statistic, computing the prediction for the symbol in that context based on a stored statistic for the symbol in a more general context.

### BACKGROUND

The exemplary embodiment relates to systems and methods for identifying subsequences in a sequence of symbols based on their surrounding context, and finds application in representing a textual document using identified repeat subsequences for interpretation of documents, such as classifying the textual document or for comparing or clustering of documents.

Language Modeling is widely used in natural language processing to provide information about short sequences of symbols, such as words or characters, drawn from a vocabulary Σ. Commonly, a scoring function ƒ(s) is defined over sequences indicating how likely the sequence s is to belong to the language, given that the sequence s is drawn from the set Σ* of possible sequences generated from Σ. Such a function is used in a variety of applications, such as in ranking a set of candidate sequences. Examples of this task include automatic speech recognition (Dikici, et al., “Classification and ranking approaches to discriminative language modeling for ASR,” IEEE Trans. on Audio, Speech, and Language Processing, 21(2):291-300, 2013, “Dikici 2013”), machine translation (Blackwood, “Lattice rescoring methods for statistical machine translation,” PhD thesis, University of Cambridge, 2010), parsing (Collins, et al., “Discriminative reranking for natural language parsing,” Computational Linguistics, 31(1):25-70, 2005, “Collins 2005”), and natural language generation (Langkilde, et al., “The practical value of n-grams in generation,” Proc. 9th Int'l Workshop on Natural Language Generation, pp 248-255, 1998).

Language modeling often uses n-gram models, in which a symbol is predicted based on the preceding n symbols. This has the additional advantage of providing a straightforward generative model, where symbols are generated one after the other. The resulting scoring function ƒ is therefore also a probability distribution:

$$p ( s = {s}_{1} … {s}_{n} ) = {\prod }_{i = 1}^{n} p ( {s}_{i} \vert {s}_{i - n} … {s}_{i - 1} )$$

where s is prepended with special starting symbols so that s₀, s₋₁, . . . , s₁₋ₙ are well-defined.

Such models restrict the context to the symbols to the left of the word for which a prediction is made. Smoothing techniques may be applied to account for unseen sequences in the training set.

Other approaches use both left and right contexts. For example, the word2vec model (Mikolov, et al., “Efficient estimation of word representations in vector space,” arXiv:1301.3781, 2013, “Mikolov 2013”) uses both “past” (symbols to the left) and “future” (symbols to the right) contexts in order to predict a given symbol. These approaches, however, make use of neural networks.

In discriminative language models, an attempt is made to optimize the model for an end-task, rather than focusing on estimating a true probability distribution over sequences. Such models have been used, for example, for Automated Speech Recognition (ASR) (Dikici 2013, Collins 2005). A disadvantage of such methods is that they do not transfer well to other tasks.

Neural language models use neural networks as underlying tools for prediction the next symbols (Bengio, et al., “A Neural Probabilistic Language Model,” J. Machine Learning Res., 3:1137-1155, 2003; Mikolov 2013). By mapping words into real-vector embeddings, these methods benefit from the power of continuous space, and avoid the drawbacks of discrete counts (notably when that count is 0 resulting in complex smoothing techniques). Despite a better performance in general, as measured by perplexity, n-gram based models are often favored over neural network-based methods, due to their easiness of use, speed in training, scalability and storage space (Jozefowicz, et al., “Exploring the Limits of Language Modeling,” arXiv:1602.02410, 2016).

### INCORPORATION BY REFERENCE

The following references, the disclosures of which are incorporated herein in their entireties by reference, are mentioned:

U.S. Pub. No. 20140229160, published on Aug. 14, 2014, entitled BAG-OF-REPEATS REPRESENTATION OF DOCUMENTS, by Matthias Gallé describes a system and method for representing a document based on repeat subsequences.

U.S. Pub. No. 20140350917, published Nov. 27, 2014, entitled IDENTIFYING REPEAT SUBSEQUENCES BY LEFT AND RIGHT CONTEXTS, by Matthias Gallé describes a method of identifying repeat subsequences of symbols that are left and right context diverse.

U.S. Pub. No. 20150100304, published Apr. 9, 2015, entitled INCREMENTAL COMPUTATION OF REPEATS, by Matías Tealdi, et al., describes a method for computing certain classes of repeats using a suffix tree. U.S. Pub. No. 20150370781, published Dec. 24, 2015, entitled EXTENDED-CONTEXT-DIVERSE REPEATS, by Matthias Gallé, describes a method for identifying repeat subsequences based a diversity of on their extended contexts.

The following relate to training a classifier and classification: U.S. Pub. No. 20110040711, entitled TRAINING A CLASSIFIER BY DIMENSION-WISE EMBEDDING OF TRAINING DATA, by Perronnin, et al.; and U.S. Pub. No. 20110103682, entitled MULTI-MODALITY CLASSIFICATION FOR ONE-CLASS CLASSIFICATION IN SOCIAL NETWORKS, by Chidlovskii, et al.

The following relates to a bag-of-words format: U.S. Pub. No. 20070239745, entitled HIERARCHICAL CLUSTERING WITH REAL-TIME UPDATING, by Guerraz, et al.

### BRIEF DESCRIPTION

In accordance with one aspect of the exemplary embodiment, a symbol prediction method includes storing a statistic for each of a set of symbols w in at least one context, each context including a string of k preceding symbols and a string of l subsequent symbols, the statistic being based on observations of a string kwl in training data. For an input sequence of symbols, a prediction is computed for at least one symbol in the input sequence, based on the stored statistics. The computing includes, where the symbol is in a context in the sequence not having a stored statistic, computing the prediction for the symbol in that context based on a stored statistic for the symbol in a more general context.

At least part of the method may be implemented by a processor.

In accordance with another aspect, a symbol prediction system includes a model which employs stored statistics for computing a probability for at least one symbol in an input sequence of symbols. The stored statistics include a statistic for each of a set of symbols w in at least one context, each context including a string of k preceding symbols and a string of l subsequent symbols, the statistic being based on observations of a respective string kwl in training data. A prediction component inputs an input sequence into the model for computing the probability, the computing including, where the symbol is in a context in the sequence not having a stored statistic, predicting a probability for the symbol in that context based on a stored statistic for the symbol in a more general context. A processor implements the prediction component.

In accordance with another aspect, a symbol prediction method includes computing an occurrence count for each of a set of symbols w in at least one context. Each context includes a string of k preceding symbols and a string of l subsequent symbols. The statistic is based on observations of a string kwl in training data. For an input sequence of symbols, the method includes computing a prediction for at least one symbol in the input sequence, based on the computed statistics. The computing includes, where the symbol is in a context in the sequence having a stored statistic, computing the prediction for the symbol based on the stored statistic for the symbol in that context and where the symbol is in a context in the sequence not having a stored statistic, computing the prediction for the symbol in that context based on a stored statistic for the symbol in a more general context.

### BRIEF DESCRIPTION OF THE DRAWINGS

FIG. 1 is a functional block diagram of a prediction system in accordance with one aspect of the exemplary embodiment;

FIG. 2 is a flow chart illustrating a prediction method in accordance with another aspect of the exemplary embodiment;

FIG. 3 illustrates a sequence of symbols (words) and context for one of the words; and

FIG. 4 shows a back-off context for the considered word in the sequence of FIG. 3.

### DETAILED DESCRIPTION

The exemplary embodiment relates to a system and method for identifying subsequences of symbols using a gapped sequence model.

The exemplary system and method extend the notion of context of traditional n-gram models to integrate both past and future symbols. Smoothing techniques can be adapted the definition of context used herein. An evaluation of the method shows significant and consistent improvement in symbol prediction. The method finds application in a variety of fields, such as language identification and in ranking (or scoring) of machine translations (e.g., statistical machine translations), text sequences generation from spoken utterances, or text sequences generated from a canonical or logical form in natural language generation.

The exemplary n-gapped model (where n is the total number of preceding and subsequent context symbols) is a random field in which the score for a sequence can be computed as the product of probabilities, one for each symbol, involving both the preceding and next symbols (whereas conventional n-gram models involve only preceding symbols).

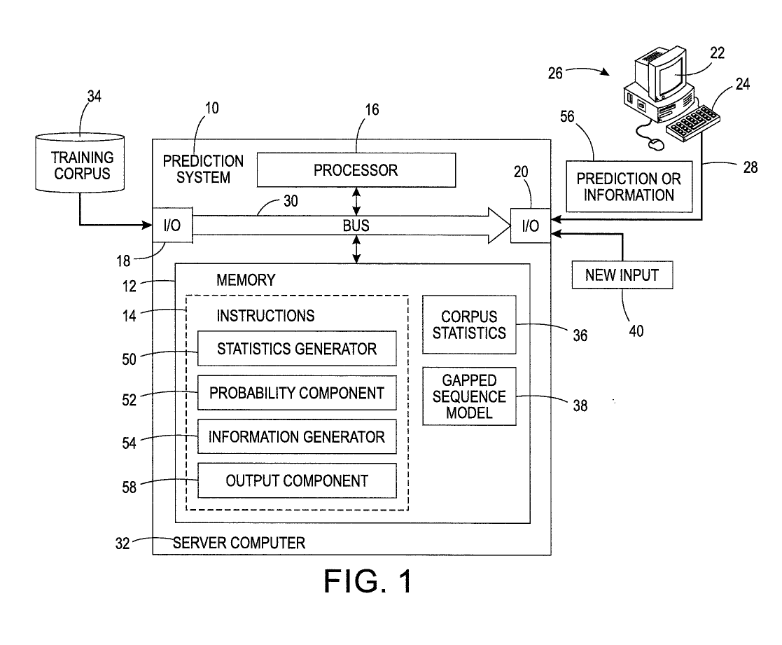

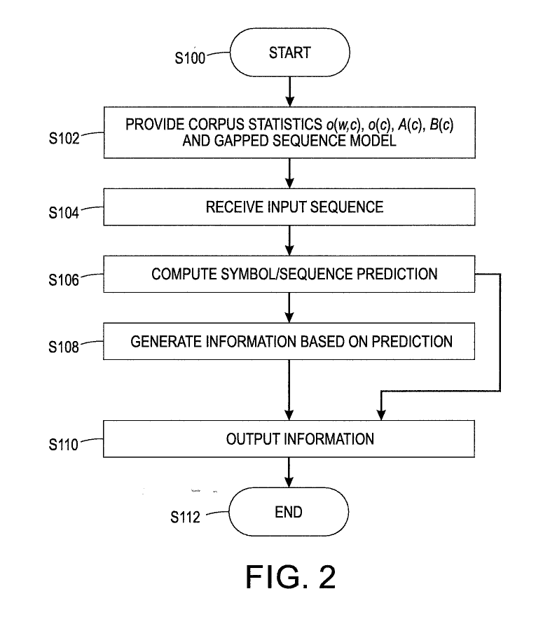

With reference to FIG. 1, a functional block diagram of a computer-implemented prediction system 10 is shown. The illustrated computer system 10 includes memory 12 which stores software instructions 14 for performing the method illustrated in FIG. 2 and a processor 16 in communication with the memory for executing the instructions. The system 10 also includes one or more input/output (I/O) devices, such as a network interface 18 and a user input output interface 20. The I/O interface 20 may communicate with one or more of a display 22, for displaying information to users, speakers, and a user input device 24, such as a keyboard or touch or writable screen, and/or a cursor control device, such as mouse, trackball, or the like, for inputting text and for communicating user input information and command selections to the processor device 16. These components may be part of a client computing device 26 in communication with the system via a wired or wireless connection such as the Internet 28. The various hardware components 12, 16, 18, 20 of the system 10 may all be connected by a data/control bus 30.

The computer system 10 may include one or more computing devices 32, such as a PC, such as a desktop, a laptop, palmtop computer, portable digital assistant (PDA), server computer, smartphone, tablet computer, pager, combination thereof, or other computing device capable of executing instructions for performing the exemplary method.

The memory 12 may represent any type of non-transitory computer readable medium such as random access memory (RAM), read only memory (ROM), magnetic disk or tape, optical disk, flash memory, or holographic memory. In one embodiment, the memory 12 comprises a combination of random access memory and read only memory. In some embodiments, the processor 16 and memory 12 may be combined in a single chip. Memory 12 stores instructions for performing the exemplary method as well as the processed data.

The network interface 18 allows the computer to communicate with other devices via a computer network, such as a local area network (LAN) or wide area network (WAN), or the internet, and may comprise a modulator/demodulator (MODEM) a router, a cable, and/or Ethernet port.

The digital processor device 16 can be variously embodied, such as by a single-core processor, a dual-core processor (or more generally by a multiple-core processor), a digital processor and cooperating math coprocessor, a digital controller, or the like. The digital processor 16, in addition to executing instructions 14 may also control the operation of the computer 32.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The system has access to a training corpus 34 of sequences or to statistics 36 generated from the corpus. Each sequence in the corpus 34 includes a set of symbols, such as words, characters, or biological symbols drawn from a vocabulary of symbols. For example in the case of words, the sequences in the corpus may be human-generated sentences in a natural language, such as English or French. The statistics 36 may include, for each symbol (or at least some symbols) observed in the training corpus, a count of its occurrences, as well as counts for the symbol occurring in different contexts, at least one context including a set of symbols to the left (preceding the symbol) and a set of symbols to the right (following the symbol). The statistics 36 are used by a gapped sequence model 38 for predicting a probability of occurrence for a new input 40, such as a symbol (or sequence of symbols) in a context which may or may not have been observed in the training corpus 34.

The exemplary instructions 14 include a statistics generator 50, which generates the statistics 36 from the training corpus 34. The statistics generator 50 may store statistics for only a subset of the most frequent n-grams in the training corpus, each n-gram including a symbol w and up to k symbols to the left and up to l symbols to the right, the numbers k and l being the maximum number of symbols in the left and right contexts.

The probability component 52 outputs a prediction for an input symbol being in a respective context in an input sequence 40 or a prediction for a sequence of symbols, using the gapped sequence model 38. The exemplary model 38 uses relevant ones of the statistics 36 and includes a back-off operator which applies a smoothing technique for providing symbol predictions for symbols of the input sequence for which the full context has not been observed (or is below a threshold) in combination with that symbol in the training set. An information generator 54 may generate information 56 based on the computed prediction, such as a prediction as to whether the input sequence is in a given language, one of a set of candidate sequences having the highest score.

An output component 58 outputs information 56, such as the computed probability or other information based thereon.

With reference now to FIG. 2, a prediction method which may be implemented with the system of FIG. 1 is illustrated. The method starts at S100.

At S102, corpus statistics 36 and a gapped sequence model 38 are provided. The statistics 36 may be generated from a training corpus 34 by the statistics generator 50, or may have been previously generated.

At S104, a new input sequence 40 is received from a source of sequences and may be stored in memory 12 during processing.

In one embodiment, the source of sequence(s) 40 is a remote client device 26. In another embodiment the system is integral with the client device.

In another embodiment, the source is a decoder of a statistical machine translation system (SMT) which translates input text sequences in a first natural language into candidate sequence(s) in a second natural language and the gapped sequence model serves as a language model of the SMT. The a decoder may be resident on computer 32 or located on a remote computing device communicatively connected with the system 10. In another embodiment, the source is a natural language generator of a remote or local dialog system which converts structured representations of text (logical forms) to candidate natural language sequences. In another embodiment, the source is a local or remote speech-to-text converter which outputs candidate text sequences by processing input speech. In another embodiment, the source is a biological sequencer which provides candidate biological sequences, such as DNA, RNA, or protein sequences.

At S106, a prediction, e.g., as a probability or score, is computed by the prediction component for at least one symbol in the input sequence by inputting the input sequence into the gapped sequence model 38, which employs relevant ones of statistics 36 for the symbol in its context in the sequence in generating the prediction.

At S108, information 56 may be generated, by the information generator 54, based on the prediction at S106.

At S110, the information is output from the system, e.g., by the output component 58. The output may be a candidate sequence from a set of candidate sequences with the highest predicted score, a prediction as to whether the input sequence is from a given natural language, or the like.

The method ends at S112.

The method illustrated in FIG. 2 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 32 (for example, an internal hard drive of RAM), or may be separate (for example, an external hard drive operatively connected with the computer 32), or may be separate and accessed via a digital data network such as a local area network (LAN) or the Internet (for example, as a redundant array of inexpensive or independent disks (RAID) or other network server storage that is indirectly accessed by the computer 32, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphics card CPU (GPU), or PAL, or the like. In general, any device, capable of implementing a finite state machine that is in turn capable of implementing the flowchart shown in FIG. 2, can be used to implement the method. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

Further details on the system and method will now be provided.

The exemplary system and method for the prediction of a symbol inside a sequence s uses as context both past and future symbols. It is assumed that the sequence is generated from symbols drawn from a vocabulary Σ. Formally, let:

[symbol]

(sᵢ|s₁, . . . ,sᵢ₋₁,sᵢ₋₁, . . . ,s_{|s|})=p(sᵢ|sᵢ₋ₖ, . . . ,sᵢ₋₁,sᵢ₊₁, . . . ,sᵢ₊ₗ)

i.e., the probability of observing a symbol sᵢ given all previous and subsequent symbols in the sequence is considered equivalent to the probability of observing symbol sᵢ, given the k previous symbols in combination with the [symbol] subsequent symbols, where, in general, k≧1, [symbol] ≧1, (k+ [symbol] )<|s|−1, and |s| is the number of symbols in the sequence.

In the exemplary method, a context c of a given word (symbol) in a sequence is composed of two strings [symbol] c₁, c₂ [symbol] , with |c₁|=k, and |c₂|= [symbol] .

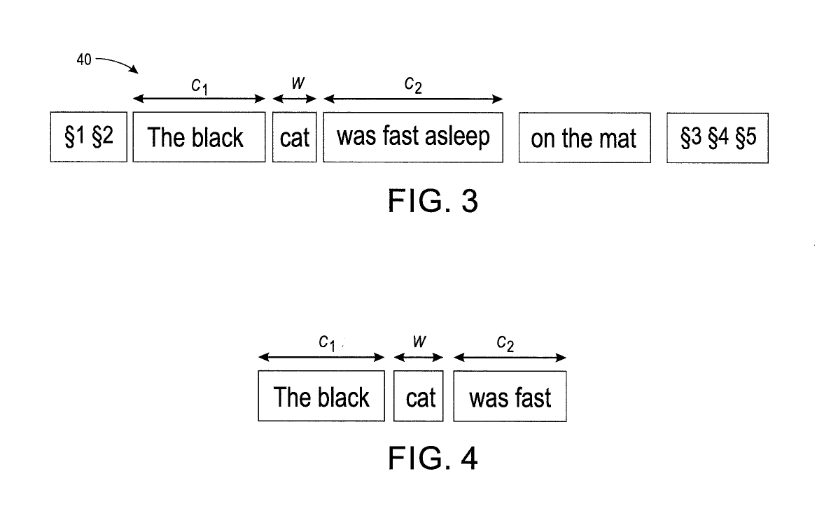

FIG. 3 illustrates an example input sequence 40, “The black cat was fast asleep on the mat.” Assume k is 2 and [symbol] is 3. Two special characters §1 and §2 may be added at the start of the sequence so that a probability can be computed for the first two words of the sequence which lack a full left context. Three special characters §3, §4 and §5 may be added at the end of the sequence so that a probability can be computed for the last three words of the sequence which lack a full right context. The probability of observing a given word w (e.g., cat) in the sequence is thus considered as the probability of observing cat its context, i.e., the occurrence count of the n-gram, The black cat was fast asleep. If this n-gram has not been observed in the corpus, a more general context may be considered, as illustrated in FIG. 4.

Pure n-gram approaches tend to perform poorly in modelling unseen sequences, because the large number of parameters of the model (|Σ|ⁿ⁺¹) are never fully observed in the training data, and even when they are the observations are extremely sparse. The exemplary method therefore uses a smoothing technique, which takes into account those unobserved statistics. Most smoothing techniques are based on the principle of using the most specific context whenever enough statistics are available, and backing off to a more generic context if that is not the case. Interpolated language modeling methods are a generalization of this, where the signal from the more generic context is always taken into account. This does not however change the nature of the information to be computed, just the way in which the context is combined.

While c denotes a context in general (i.e., c₁, c₂), ĉ denotes the next more general context (the backoff). For n-grams, if c=s₁s₂ . . . sₙ, then ĉ=s₂ . . . sₙ.

A selected smoothing technique is applied which considers the back-off when statistics are unavailable for the context c. Exemplary smoothing techniques which may be used herein are those which give non-zero probabilities to sequences not seen in the training corpus.

The information 36 to be computed for smoothing may include at least some of the following:

o(w, c): the occurrence count of a symbol w in its context c. This is the number of times that c₁wc₂ occurs in the training corpus 34 o(w, [symbol] c₁, c₂ [symbol] );

o(c): the total occurrence count of context c, i.e., the number of times c₁Wc₂ occurs in the training corpus 34; where W is any symbol in the vocabulary Σ.

A(c)={w:o(w, c)≠0}, the set of different symbols that occur in a given context, i.e., the set of different symbols w observed in c₁wc₂ in the training corpus 34.

B(c)={w:o(w, c)=0}, the set of different symbols that do not occur for a given context; which is equal to V−A(c) where V is the vocabulary (of symbols in the training set). It is assumed that V is known (a closed-world assumption where it is assumed that all symbols are seen during training).

Let context c= [symbol] v₁, . . . vₖ; w₁ . . . wₗ [symbol] , where v₁, vₖ is the set of symbols in c₁ and w₁ . . . [symbol] is the set of symbols in c₂. The back-off operator is then applied to generate a back-off context ĉ, defined as:

$$\hat{c} = ( \begin{matrix}〈 {v}_{2} , … {v}_{k} ; {w}_{1} … {w}_{𝓁} 〉 if k > 𝓁 \\ 〈 {v}_{1} , … {v}_{k} ; {w}_{2} … {w}_{𝓁} 〉 if k \leq 𝓁\end{matrix} ) \qquad ( 1 )$$

i.e., ĉ reduces the left context by one symbol and keeps the right context the same if k is larger than l and reduces the right context by one symbol and keeps the left context the same if k is equal to or smaller than l. The back-off operator may be repeated, reducing the number of symbols by one at each iteration, until the context has a threshold amount of statistics from the training set.

As will be appreciated in these expressions, alternatively, k could be the right context and l the left.

As an example, suppose k is 3 and l is 2. Suppose that symbol D is observed in the context ABC_EF in the training corpus 5 times and 6 times in the context BC_EF, but has not been observed in the context FBC_EF, i.e., o(w, c) is 0 for FBCDEF. Then, given the input sequence GFBCDEFH, o(w, c) is 0, so the back-off operator identifies ĉ as BC_EF and computes a probability for this back-off context using the statistics for this context. This is performed using a smoothing function, as described below.

The optimum size of k and l may be determined by evaluating the model 38 on a test set of sequences. In some languages, the left context is a better predictor of the symbol w, so it may be advantageous for k to be at least l, or larger. For languages which read from right to left, the reverse may be true. In one embodiment, k and l are both at least 2. In one embodiment one or both of k and l is/are greater than 2, such as 3. k and l may independently be up to 10, or up to 7, or up to 5, for example. In one embodiment, a single parameter n is defined such that if n is even,

$$k = 𝓁 = \frac{n}{2} ,$$

and if n is odd,

$$k = 𝓁 + 1 = \frac{n + 1}{2} .$$

This allows for a single parameter n, simplifying comparison with the n-gram models.

### Smoothing Techniques

Various smoothing functions are contemplated for computing the probability p(w|c). In general, any smoothing technique which is suitable for use in an n-gram model can be used for the gapped sequence model. The exemplary smoothing technique computes a probability p(w|c) for a word in its context as a function of the count of the word in its context ƒ(o(w|c)), if this is available (ƒ(o(w|c))<o(w|c)), and of the count of the word in a more general context otherwise.

In one embodiment, the Absolute Discount back-off may be applied as the smoothing function, as described, for example, in Manning, et al., “Foundations of statistical natural language processing,” vol. 999, MIT Press, 1999 (hereinafter, Manning 1999), as follows:

In this embodiment, an absolute discounting strategy is used, reserving part of the probability mass for an unseen symbol. The occurrence of a symbol in its context is then defined as: o*(w, c)=o(w, c)−β, where β is a discount factor having a value between 0 and 1. The discount factor β can be optimized on a development set.

The probability of a word w occurring in context c is then defined recursively as:

$$p ( w \vert c ) = ( \begin{matrix}\frac{{o}^{*} ( w , c )}{o ( c )} & if w ∈ A ( c ) \\ α ( c ) * \frac{p ( w \vert \hat{c} )}{{\sum }_{v ∈ B ( c )} p ( v \vert \hat{c} )} & otherwise\end{matrix} \qquad ( 2 )$$

(or is a function thereof), where α(c) is a normalizing factor for context c and v represents a symbol in vocabulary V (the symbols observed in training).

Eqn. (2) states that if the symbol w is in the set A(c) then the probability for the symbol w in context c is the number of occurrences of the symbol in that context o(w, c) minus β, divided by the total occurrence count of context o(c). If the symbol w is not in the set A(c), i.e., is in B(c), then the probability is computed as a function of the normalization factor α(c) and the probability of the word in the more general context p(w|ĉ), divided by the sum of the probability p(v|ĉ) in the more general context for each symbol v in B(c).

The normalization factor α(c) for a given context is defined as:

$$1 - {\sum }_{v ∈ A ( c )} \frac{{o}^{*} ( v , c )}{o ( c )}$$

i.e., 1 minus the sum, over all symbols v in the set A(c), of the occurrence count of the symbol v in the more general context o*(v, c)=o(v, c)−β, divided by the occurrence count o(c) for the given context c.

As will be appreciated, rather than a probability, a score could be computed by ignoring the normalizing factors (denominators).

Using the definitions of the count and the backoff operator described above, the smoothing technique can be applied in the gapped language model 38.

The context is progressively reduced further if w is not in A(c) and p(w|ĉ) has not been stored. The recursion ends when n=0 (k=l=0), in which case

$$p ( w \vert c ) = \frac{o ( w )}{N} ,$$

with N being the size of the corpus (N=Σᵥ o(v)).

The Absolute discount back-off strategy is shown to provide good results in the evaluation below. However, it is to be appreciated that other smoothing techniques can be similarly extended. For example, Katz-backoff is a similar technique that uses a multiplicative discount instead. See, Manning 1999; Katz, “Estimation of probabilities from sparse data for the language model component of a speech recognizer,” IEEE Trans. on Acoustics, Speech, and Signal Processing (ASSP-35), pp. 400-401, 1987. Kneser-Ney smoothing can also be used. This method adds another type of count, the number of contexts a word occurs in (the complement of A(c)). (Kneser, et al., “Improved backing-off for m-gram language modeling,” Intl Conf. on Acoustics, Speech, and Signal Processing (ICASSP-95), pp. 181-184, 1995.

Other exemplary smoothing techniques which may be used herein are described, for example, in Chen, et al., “An Empirical Study of Smoothing Techniques for Language Modeling,” Proc. 34th Annual Meeting on Association for Computational Linguistics, pp. 310-318, 1996 “Chen 1996”, and Chen, et al., “An Empirical Study of Smoothing Techniques for Language Modeling,” Harvard TR-10-98, 1998.

These include Jelinek-Mercer smoothing (Jelinek, et al., “Interpolated estimation of Markov source parameters from sparse data,” Proc. Workshop on Pattern Recognition in Practice, 1980, also described in Chen 1998), Katz smoothing (Katz, “Estimation of probabilities from sparse data for the language model component of a speech recognizer,” IEEE Trans. on Acoustics, Speech and Signal Processing, ASSP-35(3):400-401, March 1987), Kneser-Ney smoothing (Kneser, et al., Improved backing-off for m-gram language modeling,” Proc. IEEE Intl Conf. on Acoustics, Speech and Signal Processing, vol. 1, pp. 181-184, 1995). However, other smoothing techniques may be used which give non-zero probabilities to sequences not seen in the training set.

In one smoothing technique (based on that of Chen 1996), given a word w, and a context c= [symbol] v₁, . . . vₖ; w₁ . . . [symbol] [symbol] ƒ(w, c) (“rolling” of w and c to form a sequence) is defined recursively as follows:

$$f ( w , c ) = ( \begin{matrix}w & if c is empty \\ {v}_{1} f ( w , \hat{c} ) & if k > 𝓁 \\ {w}_{1} f ( w , \hat{c} ) & if 0 < k <= 𝓁\end{matrix}$$

Now, as ƒ is bijective between the pairs of word and context, and the set of non-empty sequences, counts can be defined as follows: c(ƒ(w, c))=o(w, c). Using these counts, a probability distribution q can be defined using any formula for smoothing techniques as given in Chen (since the formulas are defined only in terms of counts and some other parameters that are obtained by cross-validation). Now, given w and c, if s is ƒ(w, c) without the last symbol, the gapped probability distribution is defined as p(w|c)=q(w|s)).

It should be noted that the simplified computation Σ_{w}_{ᵢ} c(wᵢ₋ₙ₋₁ⁱ)=c(wᵢ₋ₙ₊₁ⁱ⁻¹) does not hold. However Σ_{w}_{ᵢ} c(wᵢ₋ₙ₋₁ⁱ)=o(c), where c is the context corresponding to wᵢ₋ₙ₋₁ⁱ.

### Sequence Scoring

The probabilities for a sequence s of m symbols (such as a phrase or sentence) can be used to predict a score corresponding to the likelihood of observing the entire sequence as a function of the computed probabilities for each of the symbols in the sequence, given the respective context. This can be the product of the probabilities for each symbol in the sequence:

$$p ( s = {s}_{1} … {s}_{m} ) = {\prod }_{i = 1}^{m} p ( {s}_{i} \vert {s}_{i - k} , … , {s}_{i - 1} , {s}_{i + 1} , … , {s}_{i + 𝓁} )$$

To compute the symbol probability for symbols having a left context of less than k, s is prepended with k special starting symbols so that s₀, s₋₁, . . . , s₁₋ₖ are well-defined. Similarly, to compute the symbol probability for symbols having a right context of less than l, s is appended with l special ending symbols so that sₘ₋ₗ₊ᵢ, sₘ₋₁, . . . , sₘ, are well-defined. For the cases where special symbols are used, the counts can be obtained for the symbols when they appear at the beginning (resp. end) of a sentence. For example, in the sequence: The black cat sat on the mat., p(sᵢ|sᵢ₋ₖ, . . . , sᵢ₋₁, sᵢ₊₁, . . . sᵢ₊ₗ) for the symbol black, if k=l=2, is the probability of observing The black cat sat where The is the first word of the sentence. These statistics 36 for beginning and end of sentence words are stored in memory.

The score p(s) can be used as a ranking function to rank a set of candidate sequences. The sequence with the highest rank (or a set of X sequences, where X is at least two), and/or a set of sequences meeting a threshold probability, can then be output.

In another embodiment, information 56 output may be a score or determination that the sequence belongs to a given language, e.g., if a threshold p(s) is met (other conditions may also be considered). Alternatively, an average or other aggregate of the probability of each symbol may be used in predicting the language.

In another embodiment, given a sequence of symbols with a gap of one or more symbols, the method is used to predict the symbol in the gap from the set of possible symbols in the vocabulary. This can be useful in transcription, where a speech to text converter is unable to recognize one or more words with a threshold confidence, or in transcribing biological sequences from fragmented sequences.

The exemplary method is similar to some discriminative models, because it does not generate a probability distribution over Σ*. However, whereas existing methods optimize specifically one final task, the present method of symbol prediction can be used in a variety of tasks, such as symbol prediction and language prediction, as illustrated in the Examples below. Modeling a sequence, or being able to provide probability distributions over missing symbols, is a basic building block for many applications involving sequences, including NLP.

Without intending to limit the scope of the exemplary embodiment, the following examples illustrate application of the method.

### Examples

Two sets of experiments were performed. The first compares the performance of n-gapped language models (gap) to n-gram ones on the symbol prediction task on data from different sources. A second experiment looks at a final task, namely language identification. A dataset of Tweets in similar languages was used, and only the signal from the language model 38 is used to attribute a language to an unseen tweet.

In all cases, the discount factor β was optimized using a development set.

### 1. Symbol Prediction

Symbol prediction was evaluated with Acc@k (Accuracy at k) metric, This represents the proportion of times where the correct symbol is ranked in the top k (the proportion of symbols in the test set that are ranked with likelihood of at most k (with 1 being the most likely symbol given the context). For example, Acc@3 means the correct symbol is among the top three ranked predictions. This metric was evaluated for the following datasets:

DNA: Training was performed on one human chromosome (chromosome 20, 5 million bases), and testing on another (chromosome 21, 1 million bases). 5 k bases of chromosome 22 were used as development set. They were downloaded from http://people.unipmn.it/manzini/dnacorpus/.

Brown Corpus: an historical corpus used for NLP applications, consisting of 6.13 M characters (over a vocabulary of size 83). ⅞ of the sentences were used for training, and the remainder were used for either development or testing.

wiki-es: a partial dump of the Spanish Wikipedia, where meta-data has been stripped and only textual content is kept. The training set has 8.3 million characters, and a development+testing set had 1.04 million characters (150 different symbols in total).

The results are given in Tables 1, 2 and 3 respectively. For the gapped models, n=k+l, with k=l when n is even and k=l+1 when n is odd.

TABLE 1
Prediction DNA

| n | type | Acc@1 | Acc@2 | Acc@3 |
|---|---|---|---|---|
| 2 | n-gram | 0.3303 | 0.6129 | 0.8352 |
| | gap | 0.3272 | 0.6100 | 0.8415 |
| 3 | n-gram | 0.3279 | 0.6113 | 0.8411 |
| | gap | 0.3466 | 0.6236 | 0.8602 |
| 4 | n-gram | 0.3360 | 0.6124 | 0.8425 |
| | gap | 0.3507 | 0.6382 | 0.8643 |
| 5 | n-gram | 0.3454 | 0.6201 | 0.8492 |
| | gap | 0.3595 | 0.6421 | 0.8661 |
| 6 | n-gram | 0.3557 | 0.6292 | 0.8518 |
| | gap | 0.3696 | 0.6466 | 0.8700 |
| 7 | n-gram | 0.3607 | 0.6321 | 0.8524 |
| | gap | 0.3763 | 0.6527 | 0.8719 |
| 8 | n-gram | 0.3666 | 0.6330 | 0.8491 |
| | gap | 0.3763 | 0.6527 | 0.8719 |
| 9 | n-gram | 0.3673 | 0.6278 | 0.8430 |
| | gap | 0.3828 | 0.6508 | 0.8669 |
| 10 | n-gram | 0.3616 | 0.6153 | 0.8358 |
| | gap | 0.3793 | 0.6421 | 0.8584 |
| 11 | n-gram | 0.3568 | 0.6104 | 0.8325 |
| | gap | 0.3728 | 0.6353 | 0.8556 |

TABLE 2
Prediction Brown

| n | type | Acc@1 | Acc@2 | Acc@4 | Acc@8 | Acc@16 | Acc@32 |
|---|---|---|---|---|---|---|---|
| 2 | n-gram | 0.3951 | 0.5448 | 0.7169 | 0.8701 | 0.9606 | 0.9904 |
| | gap | 0.4755 | 0.6495 | 0.8230 | 0.9407 | 0.9889 | 0.9992 |
| 3 | n-gram | 0.4977 | 0.6499 | 0.7977 | 0.9082 | 0.9672 | 0.9918 |
| | gap | 0.6433 | 0.7933 | 0.9069 | 0.9668 | 0.9916 | 0.9993 |
| 4 | n-gram | 0.5689 | 0.7110 | 0.8326 | 0.9182 | 0.9695 | 0.9925 |
| | gap | 0.7840 | 0.8929 | 0.9553 | 0.9854 | 0.9962 | 0.9996 |
| 5 | n-gram | 0.6039 | 0.7349 | 0.8432 | 0.9211 | 0.9702 | 0.9926 |
| | gap | 0.8522 | 0.9301 | 0.9676 | 0.9868 | 0.9962 | 0.9996 |
| 6 | n-gram | 0.6177 | 0.7426 | 0.8451 | 0.9207 | 0.9696 | 0.9927 |
| | gap | 0.8911 | 0.9514 | 0.9770 | 0.9898 | 0.9965 | 0.9996 |
| 7 | n-gram | 0.6217 | 0.7437 | 0.8442 | 0.9196 | 0.9687 | 0.9926 |
| | gap | 0.9022 | 0.9546 | 0.9777 | 0.9899 | 0.9966 | 0.9996 |
| 8 | n-gram | 0.6221 | 0.7426 | 0.8425 | 0.9182 | 0.9682 | 0.9926 |
| | gap | 0.9094 | 0.9571 | 0.9783 | 0.9900 | 0.9966 | 0.9995 |
| 9 | n-gram | 0.6208 | 0.7405 | 0.8408 | 0.9175 | 0.9679 | 0.9925 |
| | gap | 0.9105 | 0.9572 | 0.9784 | 0.9900 | 0.9965 | 0.9996 |
| 10 | n-gram | 0.6194 | 0.7392 | 0.8398 | 0.9168 | 0.9675 | 0.9925 |
| | gap | 0.9118 | 0.9574 | 0.9784 | 0.9901 | 0.9966 | 0.9996 |
| 11 | n-gram | 0.6183 | 0.7381 | 0.8389 | 0.9164 | 0.9674 | 0.9925 |
| | gap | 0.9119 | 0.9575 | 0.9784 | 0.9900 | 0.9965 | 0.9996 |

TABLE 3
Prediction wiki-es

| n | type | Acc@1 | Acc@2 | Acc@4 | Acc@8 | Acc@16 | Acc@32 |
|---|---|---|---|---|---|---|---|
| 2 | n-gram | 0.3845 | 0.5371 | 0.7085 | 0.8559 | 0.9397 | 0.9795 |
| | gap | 0.4839 | 0.6599 | 0.8218 | 0.9245 | 0.9787 | 0.9968 |
| 3 | n-gram | 0.4705 | 0.6248 | 0.7737 | 0.8876 | 0.9489 | 0.9822 |
| | gap | 0.6104 | 0.7666 | 0.8812 | 0.9501 | 0.9829 | 0.9972 |
| 4 | n-gram | 0.5388 | 0.6880 | 0.8093 | 0.8993 | 0.9526 | 0.9838 |
| | gap | 0.7312 | 0.8545 | 0.9264 | 0.9679 | 0.9890 | 0.9977 |
| 5 | n-gram | 0.5759 | 0.7141 | 0.8204 | 0.9022 | 0.9535 | 0.9841 |
| | gap | 0.7925 | 0.8863 | 0.9373 | 0.9702 | 0.9890 | 0.9977 |
| 6 | n-gram | 0.5907 | 0.7225 | 0.8229 | 0.9022 | 0.9537 | 0.9842 |
| | gap | 0.8279 | 0.9039 | 0.9446 | 0.9728 | 0.9895 | 0.9976 |
| 7 | n-gram | 0.5955 | 0.7242 | 0.8223 | 0.9013 | 0.9536 | 0.9841 |
| | gap | 0.8398 | 0.9070 | 0.9450 | 0.9728 | 0.9895 | 0.9977 |
| 8 | n-gram | 0.5977 | 0.7232 | 0.8210 | 0.9001 | 0.9534 | 0.9840 |
| | gap | 0.8466 | 0.9094 | 0.9458 | 0.9730 | 0.9896 | 0.9976 |
| 9 | n-gram | 0.5980 | 0.7219 | 0.8197 | 0.8995 | 0.9532 | 0.9839 |
| | gap | 0.8484 | 0.9095 | 0.9458 | 0.9729 | 0.9896 | 0.9977 |
| 10 | n-gram | 0.5976 | 0.7208 | 0.8188 | 0.8989 | 0.9530 | 0.9840 |
| | gap | 0.8496 | 0.9096 | 0.9458 | 0.9729 | 0.9896 | 0.9977 |
| 11 | n-gram | 0.5972 | 0.7200 | 0.8180 | 0.8985 | 0.9528 | 0.9839 |
| | gap | 0.8498 | 0.9096 | 0.9458 | 0.9729 | 0.9896 | 0.9977 |

### 2. Language Prediction

Language prediction was evaluated on the TweetLID corpus (http://komunitatea.elhuyar.eus/tweetlid/), using a character based model for each different language. Since a way to recognize undefined or unknown languages was not implemented, the method was only evaluated on tweets of known language. A language model 38 was created for each language, and unseen tweets (in the test set) were attributed to the model who maximized average prediction score over all characters. Accuracy results are shown in Table 4. A better performance of the present method was observed in general, especially for greater values of the context size.

It should be noted that in the extension of the method to predicting sequences, p(s)=Πᵢ p(sᵢ|sᵢ₋ₖ, . . . , sᵢ₋₁, sᵢ₊₁, . . . sᵢ₊ₗ) is not a true probability distribution, and therefore perplexity of that distribution over new sequences cannot be used as a fair comparison. This is related to the fact that the exemplary language model is not generative. While constraining for some applications in which a probability function is needed, for many applications a simple ranking score suffices. This is true for all applications that require a simple re-ranking of a set of proposals, in order to find the most likely sequence

TABLE 4
Accuracy on language prediction

| n | Acc n-gram | Acc gap |
|---|---|---|
| 2 | 0.8927 | 0.8915 |
| 3 | 0.9229 | 0.9175 |
| 4 | 0.9258 | 0.9265 |
| 5 | 0.9253 | 0.9287 |
| 6 | 0.9233 | 0.9270 |
| 7 | 0.9220 | 0.9257 |
| 8 | 0.9208 | 0.9253 |
| 9 | 0.9202 | 0.9251 |
| 10 | 0.9193 | 0.9247 |
| 11 | 0.9195 | 0.9249 |

The examples show that for the same number of seen symbols (n), the gapped sequence method (gap) performs substantially and consistently better than the traditional n-gram approach across a diverse range of sequences. The use of the method in a simple end-to-end application (where the signal of the language model is the only one used) shows increased performance.

The results suggest that for this application, on the data used, a value of 5 for n gives the highest accuracy, i.e., k=3, l=2.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. In a machine translation system which generates input text sequences of symbols by translation of source sentences or in a dialog system which generates input text sequences of symbols by converting structured representations of text to input sequences in a natural language, a symbol prediction method comprising:
storing a statistic for each of a set of symbols w in at least one context, each context including a string of k preceding symbols and a string of l subsequent symbols, where k is at least 1 and l is at least 1, the statistic being based on observations of a string kwl in training data;
with a processor, for an input text sequence of symbols, computing a prediction for at least one symbol in the input sequence, based on the stored statistics, the computing including, where the symbol is in a context in the sequence not having a stored statistic, computing the prediction for the symbol in that context based on a stored statistic for the symbol in a more general context;
computing a prediction for the input sequence of symbols based on the predictions for the symbols in the input sequence; and
outputting information based on the computed prediction for the at least one symbol, the information comprising:
a prediction for the input sequence of being in a given language, or
a candidate input sequence with a highest prediction from a set of candidate input sequences, the set of candidate input sequences including the input sequence.

2. The method of claim 1, further comprising computing a prediction for the input sequence of symbols based on the predictions for the symbols in the input sequence.

3. The method of claim 2, wherein the input sequence comprises a plurality of candidate sequences and the method includes ranking the candidate sequences based on the predictions for the candidate sequences.

4. (canceled)

5. (canceled)

6. The method of claim 1, wherein the information comprises a prediction of a symbol missing from the input sequence.

7. (canceled)

8. (canceled)

9. The method of claim 1, wherein the symbols are selected from words and characters.

10. The method of claim 1, wherein when the prediction for the symbol in the context is based on a stored statistic for the symbol in a more general context, the method comprises iteratively reducing one of the string of preceding symbols and the string of subsequent symbols by one symbol until there is a statistic for the word in the more general context in the stored statistics.

11. The method of claim 1, wherein at least one of k and l is at least 2.

12. The method of claim 1, wherein the computing a prediction for at least one symbol in the input sequence comprises reserving a part of a probability for a symbol in a first context having a stored statistic for computing a probability for the symbol in a context not having a stored statistic.

13. The method of claim 12, wherein the reserving includes applying a smoothing technique which provides non-zero probabilities for symbols in contexts not having a stored statistic.

14. The method of claim 13, wherein the smoothing technique is selected from absolute discount back-off, Jelinek-Mercer smoothing, Katz smoothing, and Kneser-Ney smoothing.

15. The method of claim 14, wherein the stored statistics include:
o(w, c): an occurrence count of a symbol w in its context c in the training data;
o(c): a total occurrence count of context c in the training data;
A(c)={w:o(w, c)≠0}, the set of different symbols that occur in a given context in the training data; and
B(c)={w:o(w, c)=0}, the set of symbols v that do not occur for a given context in the training data.

16. The method of claim 15, wherein the smoothing technique is absolute discount back-off and the prediction for a symbol in a context c is computed as a probability:
$$p ( w \vert c ) = ( \begin{matrix}\frac{{o}^{*} ( w , c )}{o ( c )} & if w ∈ A ( c ) \\ α ( c ) * \frac{p ( w \vert \hat{c} )}{{\sum }_{v ∈ B ( c )} p ( v \vert \hat{c} )} & otherwise\end{matrix}$$
or a function thereof,
where
$$\frac{{o}^{*} ( w , c )}{o ( c )} = o ( w , c ) - β , \\ α ( c ) = 1 - {\sum }_{v ∈ A ( c )} \frac{{o}^{*} ( v , c )}{o ( c )} ,$$
0<β<1, and
p(w|ĉ) is the stored probability of the symbol in a more general context.

17. A computer program product comprising a non-transitory recording medium storing instructions, which when executed on a computer, causes the computer to perform the method of claim 1.

18. A system comprising memory storing instructions for performing the method of claim 1 and a processor in communication with the memory which executes the instructions.

19. A symbol prediction system comprising:
a model which employs stored statistics for computing a probability for at least one symbol in an input sequence of symbols, the stored statistics comprising, a statistic for each of a set of symbols w in at least one context, each context including a string of k preceding symbols and a string of l subsequent symbols, where k is at least 1 and l is at least 1, the statistic being based on observations of a respective string kwl in training data;
a prediction component which inputs an input sequence into the model for computing the probability, the computing including, where the symbol is in a context in the sequence not having a stored statistic, predicting a probability for the symbol in that context based on a stored statistic for the symbol in a more general context;
an output component which outputs information based on the predicted probability, the information including:
an identified language for the input sequence, or
where the input sequence is one of a set of candidate machine translations of a source sequence, a rank or score for the input sequence; and
a processor which implements the prediction component and the output component.

20. The system of claim 19, further comprising a statistics generator which generates the stored statistics from the training data.

21. A prediction method comprising:
computing an occurrence count for each of a set of symbols w in at least one context, each context including a string of k preceding symbols and a string of l subsequent symbols, where k is at least 1 and l is at least 1, the statistic being based on observations of a string kwl in training data;
generating candidate sequences comprising:
with a decoder of a machine translation system, translating an input text sequence in a first natural language into candidate sequences in a second natural language, or
with a natural language generator of a dialog system converting a structured representation of text to candidate sequences in a natural language;
with a processor, for each of the candidate text sequences, computing a prediction for at least one symbol in the candidate text sequence, based on the computed statistics, the computing including, where the symbol is in a context in the sequence having a stored statistic, computing the prediction for the symbol based on the stored statistic for the symbol in that context and where the symbol is in a context in the sequence not having a stored statistic, computing the prediction for the symbol in that context based on a stored statistic for the symbol in a more general context; and
based on the computed predictions, outputting one of the candidate sequences.

22. The system of claim 19, further comprising a decoder of a statistical machine translation system which translates input text sequences in a first natural language into candidate sequences in a second natural language and wherein the model serves as a language model statistical machine translation system.

23. In a biological sequencer,
storing a statistic for each of a set of biological symbols w in at least one context, each context including a string of k preceding biological symbols and a string of l subsequent biological symbols, where k is at least 1 and l is at least 1, the statistic being based on observations of a string kwl in training data, the training data comprising sequences of biological symbols;
providing a candidate biological sequence of symbols with a gap of one or more symbols in a context including a string of k preceding biological symbols and a string of l subsequent biological symbols;
with a processor, computing a prediction for at least one symbol in the gap, based on the stored statistics, the computing including, where the symbol is in a context in the sequence not having a stored statistic, computing the prediction for the symbol in the context based on a stored statistic for the symbol in a more general context; and
outputting a biological sequence based on the computed prediction.
